(19) United States
(12) Patent Application Publication
(10) Pub. No.: US 2008/0029703 A1
(43) Pub. Date: Feb. 7, 2008

(54) SYSTEM AND METHOD FOR RANGE SELECTABLE MOTION DETECTION

(75) Inventor: William S. DiPoala, Fairport, NY (US)

Correspondence Address: BAKER & DANIELS LLP, 300 NORTH MERIDIAN STREET, SUITE 2700, INDIANAPOLIS, IN, 46204, US

(73) Assignee: ROBERT BOSCH GMBH, Stuttgart (DE)

(21) Appl. No.: 11/461,543

(22) Filed: Aug. 1, 2006

(51) Int. Cl. G01J 5/02

(52) U.S. Cl. 250/342; 250/DIG. 1

(57) ABSTRACT

The present invention is directed to a method and system for regulating coverage range within an intrusion detection system. The intrusion detection system may include at least two sensors, each of the sensors having an individual range of coverage. The system may additionally include at least two predetermined settings for determining a collective coverage range of the at least two sensors. A selectable adjustment mechanism may be provided for allowing an installer to select an optimal predetermined setting from the at least two predetermined settings for regulating the collective coverage range of the at least two sensors.

### TECHNICAL FIELD

Embodiments of the present invention relate to motion detectors. More particularly, embodiments of the invention are directed to providing selectable range control for motion detectors.

### BACKGROUND OF THE INVENTION

Currently, in the field of security systems, motion detectors are generally provided to detect intruders. Motion detectors may include sensors such as for example two passive infrared (PIR) sensors for detecting intruders. Typically such systems may include a pair of lenses for focusing infrared radiation onto each PIR sensor. Each PIR sensor may include a pair of spaced pyroelectric elements. Each pyroelectric element may cooperate to provide the motion detection system with multiple discrete fields of view. Alternatively, the motion detection system may include a dual detector having one or more PIR sensors and a microwave (MW) sensor. In this dual configuration, each sensor may provide the motion detection system with a different field of view. Furthermore, optical systems of these motion detection systems may include mirrors and/or reflectors that interact to define and/or divide multiple distinct or overlapping fields of view.

Motion detectors may have different optimal characteristics depending upon the area of the space to be protected. Accordingly, an installer is typically required to be familiar with the size of the area to be protected in order to provide a suitable motion detection unit. As a result of this requirement, some motion detection systems have been developed that provide an adjustable range. For example, U.S. Pat. No. 5,276,427 discloses a dual sensor motion detection system in which the sensitivity and coverage of the sensors are automatically adjusted so that both sensors detect each event. If one sensor detects an event and the other does not, the automatic adjustment may lower the sensitivity of the sensor that detected the event. Another example of such a system is disclosed in U.S. Pat. No. 5,757,004. A motion detection system is provided having external range adjustment. The motion detection system includes a threaded traveling member, accessible from an outside unit for adjusting the range of the unit. The arrangement allows the depth of the field of view to be adjusted over a range of twenty to forty feet. The adjustment is accomplished through relative movement of a sensor in relation to a lens matrix of the motion detection system. However, such adjustments, made mechanically by a user, can yield imprecise and inaccurate results.

Thus, currently, an installer may need to stock and carry several different motion detectors with different detection ranges. Installing a motion detector with a detection range rating that exceeds the room size can increase the probability of false alarms.

Accordingly, a solution is needed that includes a simple selectable adjustment mechanism that allows an installer to adjust the detection range or select from multiple available detection ranges of a motion detection system based an a required area of coverage.

### BRIEF SUMMARY OF THE INVENTION

In one aspect of the invention, an intrusion detection system may be provided that includes at least two sensors, each of the sensors having an individual range of coverage. The intrusion detection system may additionally include at least two predetermined settings for determining a collective coverage range of the at least two sensors and a selectable adjustment mechanism for allowing an installer to select an optimal predetermined setting from the at least two predetermined settings for regulating the collective coverage range of the at least two sensors.

In yet an additional aspect of the invention, a method is disclosed for providing regulation of a coverage range of an intrusion detection system having at least two sensors, each sensor having an individual range of coverage. The method may include providing at least two predetermined settings for determining a collective coverage range of the at least two sensors. The method may additionally include incorporating a selectable adjustment mechanism. The selectable adjustment mechanism may allow an intrusion detection system installer to select an optimal predetermined setting from the at least two predetermined settings for regulating the collective coverage range of the at least two sensors.

### BRIEF DESCRIPTION OF THE DRAWINGS

The present invention is described in detail below with reference to the attached drawings figures, wherein:

FIG. 1 is a perspective view of an installer interface in accordance with an embodiment of the invention;

FIG. 2A is a side view of a motion detection system in accordance with an embodiment of the invention;

FIG. 2B is a side view of a motion detection system in accordance with an alternative embodiment of the invention;

FIG. 3A illustrates graphs showing long range coverage for a motion detection system in accordance with an embodiment of the invention;

FIG. 3B illustrates graphs showing short range coverage in accordance with an embodiment of the invention;

FIG. 3C is a diagram illustrating coverage direction of multiple sensors in a motion detection system in accordance with an embodiment of the invention;

FIG. 4 is a schematic block diagram illustrating a motion detection system configuration in accordance with an embodiment of the invention;

FIG. 5 is a side view of the detector assembly of FIG. 2A and associated infrared detection zones and microwave detection area within a protected space that is monitored by the detector assembly;

FIG. 6A is a plot of a voltage signal from an upper infrared detector of the detector assembly of FIG. 2A versus time as a result of a human walking within a protected space at a distance of approximately five feet from the detector assembly;

FIG. 6B is a plot of a voltage signal from an upper infrared detector of the detector assembly of FIG. 2A versus time as a result of a human walking within a protected area at a distance of approximately seventeen feet from the detector assembly;

FIG. 6C is a plot of a voltage signal from the upper infrared detector of the assembly of FIG. 2A versus time as a result of a human walking within a protected space at a distance of approximately forty feet from the detector assembly;

FIG. 6D is a plot of a voltage signal from a lower infrared detector of the detector assembly of FIG. 2A versus time as a result of a human walking within a protected area at a distance of approximately five feet from the detector assembly;

FIG. 6E is a plot of a voltage signal from a lower infrared detector of the detector assembly of FIG. 2A versus time as a result of a human walking within a protected area at a distance of approximately seventeen feet from the detector assembly;

FIG. 6F is a plot of a voltage signal from a lower infrared detector of the detector assembly of FIG. 2A versus time as a result of a human walking within a protected space at a distance of approximately forty feet from the detector assembly;

FIG. 6G is a plot of a voltage signal from a microwave transceiver of the detector assembly of FIG. 2A versus time as a result of a human walking within a protected space at a distance of approximately five feet from the detector assembly;

FIG. 6H is a plot of a voltage signal from a microwave transceiver of the detector assembly of FIG. 2A versus time as a result of a human walking within a protected space at a distance of approximately seventeen feet from the detector assembly;

FIG. 6I is a plot of a voltage signal from a microwave transceiver of the detector assembly of FIG. 2A versus time as a result of a human walking within a protected space at a distance of approximately forty feet from the detector assembly;

FIG. 6J is a plot of a voltage signal from the microwave transceiver of the detector assembly of FIG. 2A versus time as a result of a dog walking within a protected space at a distance of approximately five feet from the detector assembly;

FIG. 6K is a plot of a voltage signal from a microwave transceiver of the detector assembly of FIG. 2A versus time as a result of a dog walking within the protected space at a distance of approximately seventeen feet from the detector assembly;

FIG. 6L is a plot of a voltage signal from a microwave transceiver of the detector assembly of FIG. 2A versus time as a result of a dog walking within a protected space at a distance of approximately forty feet from the detector assembly; and

FIG. 7 is a flow chart illustrating a method in accordance with an embodiment of the invention.

### DETAILED DESCRIPTION OF PREFERRED EMBODIMENTS

Embodiments of the present invention are directed to a system and method for coverage range adjustment within an intrusion detection system.

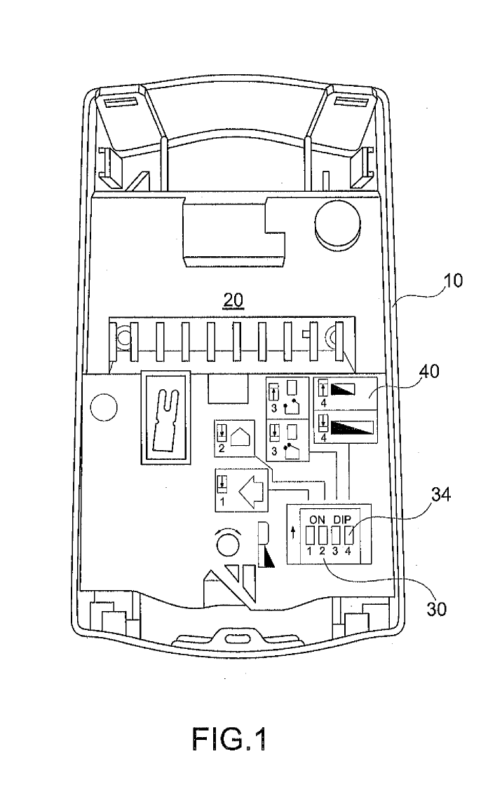

FIG. 1 illustrates an installer interface for achieving range adjustment in accordance with an embodiment of the invention. An outer housing 10 may be mounted to a wall or other location. An interface plate 20 may provide an installer with necessary information related to system settings. Multiple switches 30 may be accompanied by descriptive components in order to allow the installer to determine appropriate switch settings. In the displayed embodiment, a switch 34, (switch #4) includes a descriptive component 40. The descriptive component 40 shows short range coverage when the switch 34 is in an ON position and long range coverage when the switch 34 is in an OFF position.

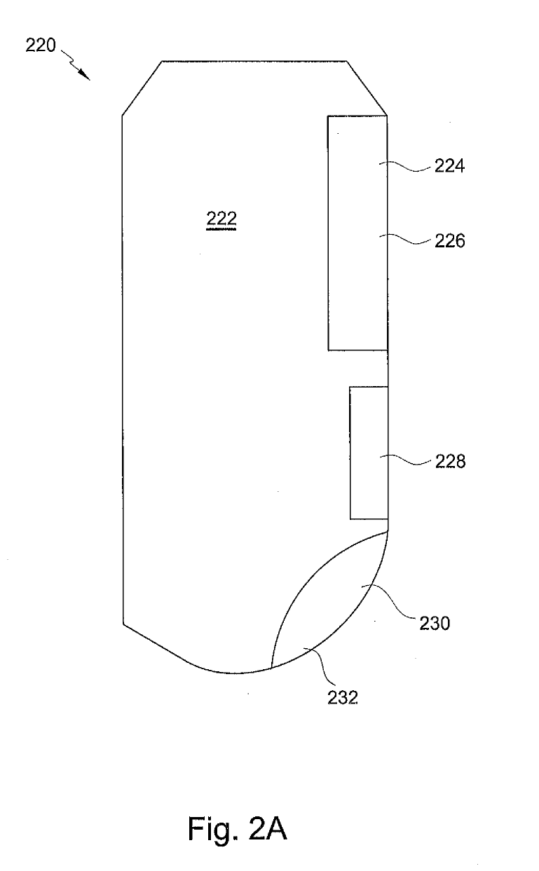

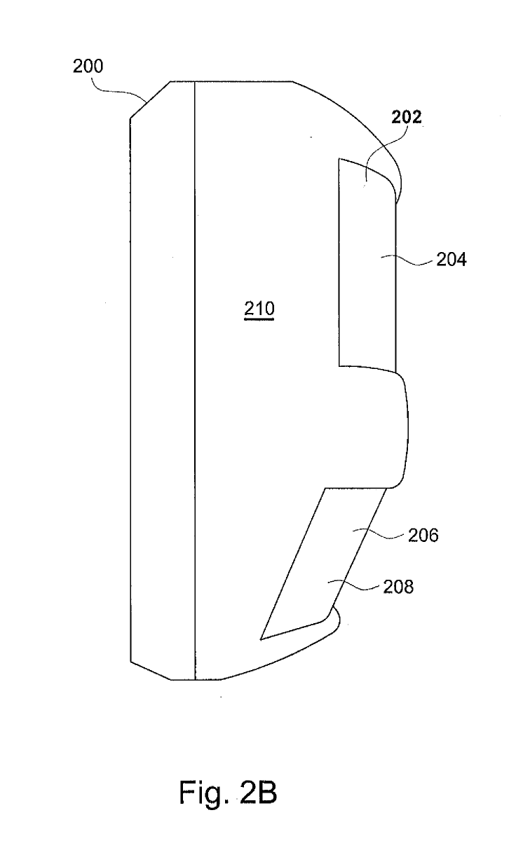

FIG. 2A is a side view of an intrusion detection system 220 in accordance with an embodiment of the invention. The intrusion detection system 220 may be equipped with a housing 222. The housing 222 may include a plurality of sensors, for instance, an upper PIR sensor 224, a lower PIR sensor 232, and a microwave sensor 228. The upper PIR sensor 224 may include a lens 226 having a relatively long focal length for long range detection and may be configured to define predetermined detection zones. The lower PIR sensor 232 may include a lens 230 and least partially disposed on a bottom end of the housing 222. As will be further explained below, each of the displayed sensors may include one or more detection zones.

FIG. 2B illustrates an intrusion detector 200 in accordance with an alternative embodiment of the invention. The intrusion detector 200 may include a housing 210. An upper PIR sensor 202 may include a lens 204 and a lower PIR sensor 206 may include a lens 208. Likewise, the PIR sensors 202 and 206 may cover pre-defined detection zones.

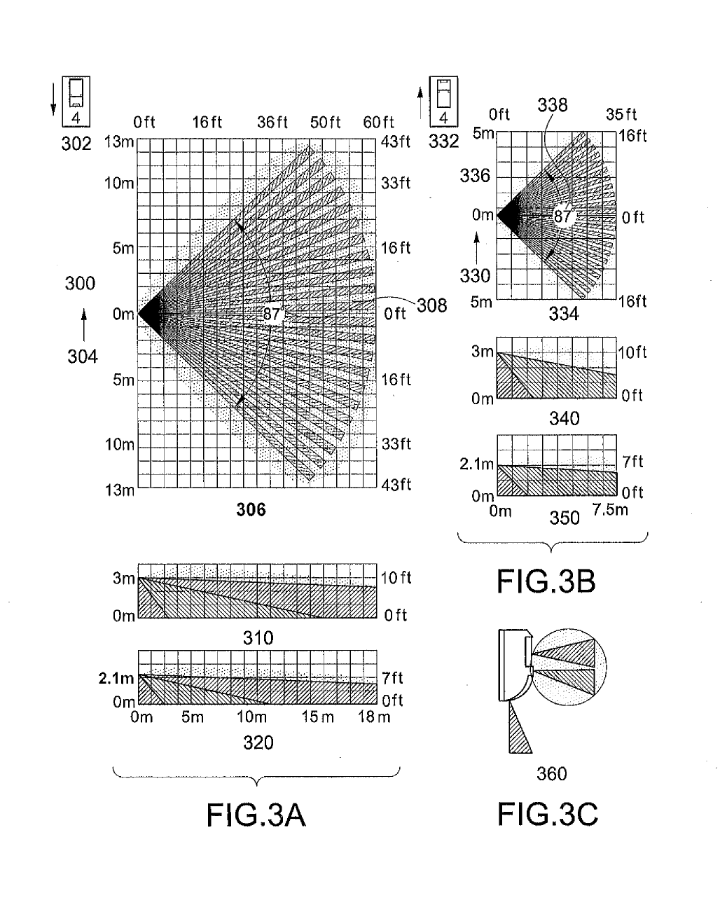

FIGS. 3A and 3B illustrate possible detection zones for the intrusion detection system embodiment of FIG. 2B. FIG. 3A illustrates the effect of maintaining a selectable adjustment mechanism in the form of a switch 302 in an OFF position in order to achieve long range coverage. FIG. 3B illustrates the effect of maintaining a selectable adjustment mechanism in the form of a switch 332 in an ON position in order to achieve short range coverage.

In graph 300 of FIG. 3A, a coverage detection area for an upper PIR sensor in accordance with an embodiment of the invention is illustrated. The coverage pattern 308 is defined by a y-axis 304 and an x-axis 306. The y-axis 304 illustrates an origin at zero (shown in meters and feet), which represents the detector location and further illustrates the distance in one direction, such as vertical distance, from the origin. The x-axis 306 represents the distance of coverage in another direction, such as horizontal distance from the detector.

Graph 310 illustrates the detection zones of the upper PIR sensor shown by the uppermost cross-hatched section, the lower PIR sensor detection zone, shown by the mid section and the lower section along the y-axis. Graph 320 illustrates coverage in a different direction in both meters and feet in accordance with an embodiment of the invention.

FIG. 3B illustrates the short range coverage that results when the switch 332 is activated and the upper PIR signals are ignored. The graph 334 illustrates a coverage range of the short range pattern that occurs when the switch is on. The short range pattern incorporates sensing by the lower PIR. The y-axis illustrates coverage from the origin in one direction and the x-axis illustrates coverage in another direction. The graphs 340 and 350 illustrate coverage of the lower PIR channel in two directions when the upper PIR channel is omitted.

FIG. 3C illustrates a sample detector with coverage directions of the upper PIR and lower PIR. As illustrated, the sensors may include both upper and lower coverage ranges.

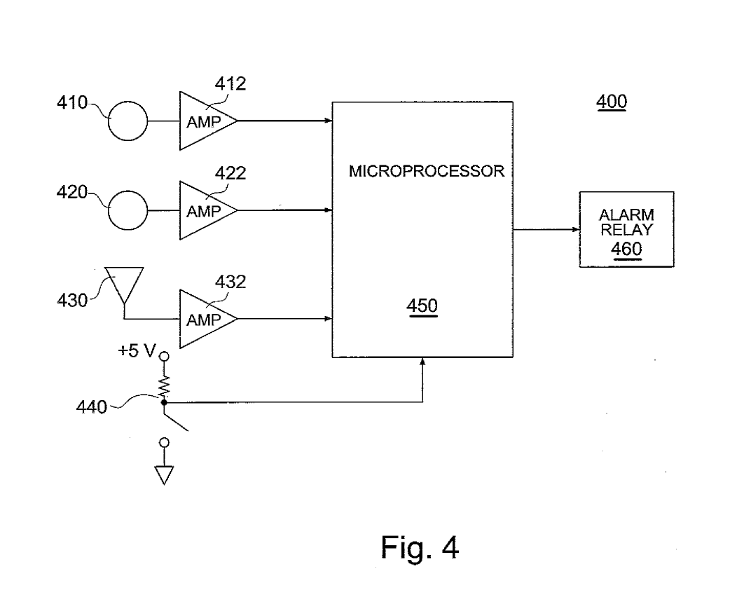

FIG. 4 illustrates a coverage range adjustment mechanism 400 for use in and in combination with the dual detector intrusion detection system shown in FIG. 2A. A further improvement in controlling the detection range can be achieved in the dual detector that uses both PIR and microwave signals. When the unit is set in short range mode, MW signals may be canceled when only upper PIR signals are detected. An upper PIR sensor 410, a lower PIR sensor 420, and a microwave sensor 430 may provide signals amplified by amplifiers 412, 422, and 432 respectively. A switch 440 has two positions, each of which instructs the microprocessor 450 with regard to treatment of the signals from the upper PIR sensor 410, the lower PIR sensor 420, and the microwave sensor 430. An alarm relay 460 may activated by the microprocessor 450 upon detection of an intrusion.

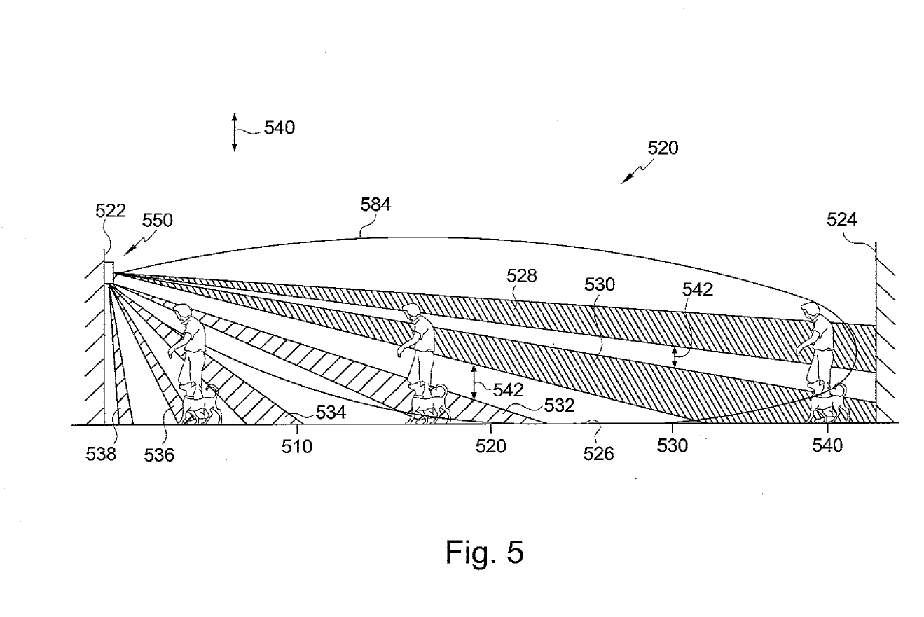

The microwave sensor 430 may be a transceiver that includes transmitting and receiving antennas. The transmitting antenna transmits microwave energy generally into a microwave detection space as will be further explained below with respect to FIG. 5. As the microwave signals impinge on an object in protected space, at least a portion of the microwave signals is reflected toward the receiving antenna. Depending on the characteristics of the reflected signal, the detector may generate a voltage signal that indicates the presence of a moving object. The amplifier 432 may be a high gain band pass amplifier and may filter out frequencies uncharacteristic of intrusion and transmit amplified signals to the microprocessor 450.

The alarm relay 460 may be operable to trigger an alarm upon detecting a security violation. The alarm system may activate any appropriate type of visible or audible alarm including both remote and proximal alarms.

The microprocessor 450 may include or be connected with a system memory that includes computer storage media in the form of volatile and/or nonvolatile memory such as read only memory (ROM) and random access memory (RAM). A basic input/output system (BIOS), containing the basic routines that help to transfer information between elements within the security system environment 100, such as during start-up, may be stored in ROM. RAM typically contains data and/or program modules that are immediately accessible to and/or presently being operated on by microprocessor 450.

The RAM may include an operating system, program data, and application program. The application programs may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including multiprocessor systems, microprocessor-based or programmable consumer electronics, minicomputers, mainframe computers, and the like.

The program modules of the microprocessor 450 may cause instructions to be executed based upon the position of the switch 440 and the activity of the sensors 310, 420, and 430. If the switch 440 is ON, the PIR subsystem may not cause the microprocessor 450 to generate an alarm based on signals in the upper channel from the upper PIR sensor 410. If no lower PIR sensor signals are detected, the microprocessor 450 may judge the target to be out of range and may therefore also ignore signals from the microwave sensor 430. However, as will be further described below, the microprocessor 450 may utilize the upper PIR signals to estimate target range.

Furthermore, although FIG. 4 illustrates a dual detector, one skilled in the art could similarly design a PIR only detector. In the PIR only detector, the microprocessor would ignore signals from the upper PIR sensor when the switch is in an ON position. With respect to both the dual detector and the PIR only embodiments, although the switch is described as facilitating short range coverage in an ON position and long range coverage in the OFF position, the reverse configuration could also be created.

FIG. 5 illustrates protected zones in greater detail. A detector 550 may be mounted on the wall 522 and may monitor a three dimensional protected space 520 defined by opposite walls 522 and 524 and a floor 526. The upper PIR sensor discussed above may detect sources of infrared energy that are disposed at least partially within upper detection zones 528 and 530. The detection zone 528 extends from the assembly 510 and intersects with the wall 524. The detection zone 530 is directed at a greater angle and intersects with the floor 526 in addition to a portion of the wall 524. The lower PIR sensor discussed above detects sources of IR energy disposed at least partially within lower detection zones 532, 534, 536, and 538.

Detection zones 528, 530, 532, 534, 536, and 538 are dispersed both vertically and in directions indicated by the double arrow 540 and horizontally in directions into and out of the page of FIG. 5. Any vertically adjacent pair of detection zones 528, 530, 532, 534, 536, and 538, has a vertical gap 542 there between. In one embodiment, gaps 542 have maximum heights of less than about 3.5 feet or 1.07 meters. In another embodiment, the gaps 542 all have maximum heights of less than about 2.5 feet or 0.76 meters. It is also possible for the gap 542 between protected zones 530 and 532 to be larger than the other gaps 542 in order to ensure that no overlap exists between detection zones 530 and 532, and thus to ensure that the upper and lower PIR sensors do not monitor overlapping portions of space.

Horizontal gaps between horizontally adjacent detection zones may be sized such that a human could not be entirely disposed there between. In one embodiment, horizontal gaps between horizontally adjacent detection zones have maximum widths of about one foot or less. In another embodiment, vertically adjacent layers of detection zones are horizontally staggered such that a cross-section of the three dimensional array of detection zones forms a tessellated or checkerboard-like pattern.

In the dual detector embodiment, the microwave sensor is capable of detecting motion within a microwave detection space 584 that is at least partially disposed within the protected space 520. In the embodiment shown in FIG. 5, the microwave detection space 584 extends about 42 feet or 12.80 m in the direction toward the wall 524. The microwave detection space 584 may also extend a similar distance, or slightly further, e.g. about 48 feet of 14.63 m in lateral directions into and out of the page of FIG. 5. The protected space 520 may be generally defined as the intersection of the microwave detection space 584 and detection zones 528, 530, 532, 534, 536, and 538.

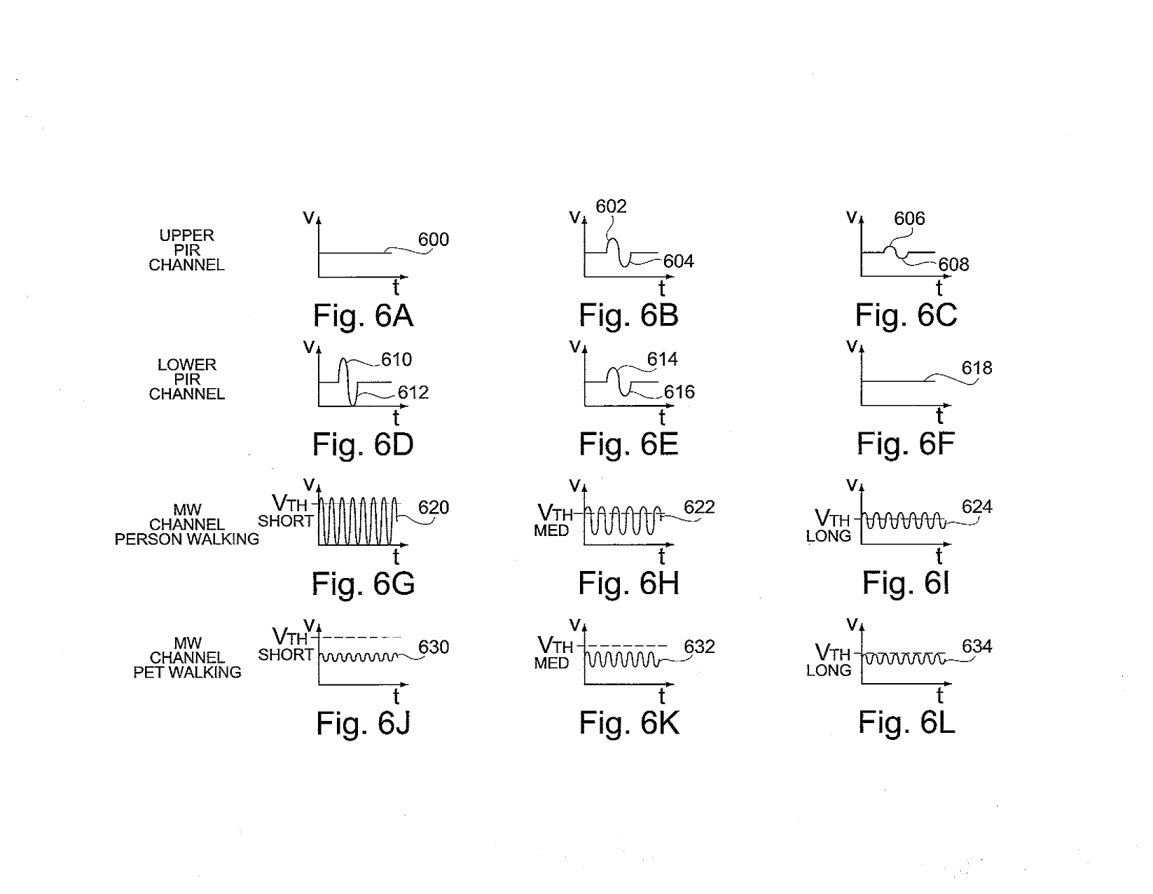

FIGS. 6A, 6B, and 6C are plots of an amplified upper PIR signal when a human stands about five feet, seventeen feet, and forty feet, respectively, away from the detector assembly 510. At five feet away, no part of the human is disposed within the detection zones 528 and 530. Thus, the signal 600 has a constant voltage level as shown in FIG. 6A. At seventeen feet away, the human is partially disposed within at least one of the detection zones 528, 530 and the signal includes a first pulse 602 followed by a second pulse 604 in the opposite direction as shown in FIG. 6B. At forty feet away, the human is again partially disposed within at least one of the detection zones 528, 530 and the signal once again includes a first pulse 606 and a second pulse in the opposite direction 608 as shown in FIG. 6C. Due to the increased distance between the human and the PIR sensor, the amplitudes of the pulses 606 and 608 are smaller than the amplitudes of the pulses 602 and 604.

FIGS. 6D, 6E, and 6F are plots of an amplified lower sensor signal when a human stands about five feet, seventeen feet, and forty feet, respectively, away from the detector assembly 510. At forty feet away, no part of the human is disposed within the detection zones 532, 534, 536, or 538. Thus a signal 618 of FIG. 6F has a constant voltage level. At seventeen feet, the human is partially disposed within the detection zone 532 and thus the signal includes a first pulse 614 and a second pulse 616 in the opposite direction as shown in FIG. 6E. At five feet away, the human is partially disposed within at least one of detection zones 532, 534, and 536 and the signal includes a pulse 610 followed by pulse 612 in the opposite direction as shown in FIG. 6D. Due to the distance differential, the amplitudes of pulses 610 and 612 are greater than the amplitudes of pulses 614 and 616.

The microprocessor 450 of FIG. 4 is able to distinguish upper sensor signals from lower sensor signals because it receives them via separate respective inputs. As can readily be seen through comparison, a relationship exists between the upper and lower sensor signals in each of the three cases. The ratio of the amplitude of the lower sensor signal to the amplitude of the upper sensor signal or vice versa varies with the distance between the target and the housing. Thus, the microprocessor 450 can extract information about the distance between the target and the housing from the amplitude ratio. The microprocessor 450 can use this extracted distance information in determining whether to generate an alarm signal that activates an alarm. Further details of such a target distance determination can be found in U.S. Pat. No. 7,034,765, which is hereby incorporated by reference.

FIGS. 6G, 6H, and 6I are plots of the output of the amplifier 432, i.e., an amplified version of the microwave signal, when a human is in motion at a location about five feet, seventeen feet, and forty feet, respectively, away from the detector assembly. As illustrated, both the amplitude and peak-to-peak voltage of the amplified signal vary inversely with the distance of the human from the detector assembly and the microwave sensor.

FIGS. 6J, 6K, and 6L are plots of an amplified microwave signal from the amplifier 432 when a small animal such as a dog or cat is in motion at a location of about five feet, seventeen feet, and forty feet, respectively from the detector assembly. Due to the smaller size of the pet, the amplified signal has a smaller amplitude and peak-to-peak voltage when generated by a pet presence rather than a human presence. Both the amplitude and peak-to-peak voltage of the amplified signal may have a positive relationship, i.e. vary non-inversely, with the distance of the pet from the detector assembly and microwave transceiver. The microwave transceiver does not detect pets well in the range of zero to ten feet (3.05 m). As can be seen in FIG. 5, a pet that is between zero and ten feet from the wall 522 is generally disposed below and outside of the microwave detection space 584.

The relationship between the lower and upper sensor signals that varies with the distance of the human from the housing also generally holds true for a pet or other small animal. For example, when a dog is located approximately five feet from the sensor, the dog will generate a signal in the lower PIR sensor and no signal in the upper PIR sensor. However, in the case of a pet, the signal generated by the lower PIR sensor will typically have a smaller amplitude than for a human. For locations progressively further away from the detector, the pet will continue to generate a signal in only the lower PIR channel until the pet approaches the point where the detection zone 530 is sufficiently close to the floor 526 such that the pet can be detected by the upper PIR sensor. At this point, it may be possible for the pet to be present in a detection zone of both the upper PIR sensor and the lower PIR sensor in which case, signals similar to those depicted in FIGS. 6A and 6D, will be generated. The threshold voltages shown in FIGS. 6G-6L can be implemented to better distinguish between humans and pets in the detection zones. This determination is described in greater detail in U.S. Pat. No. 7,034,675 which is incorporated herein by reference.

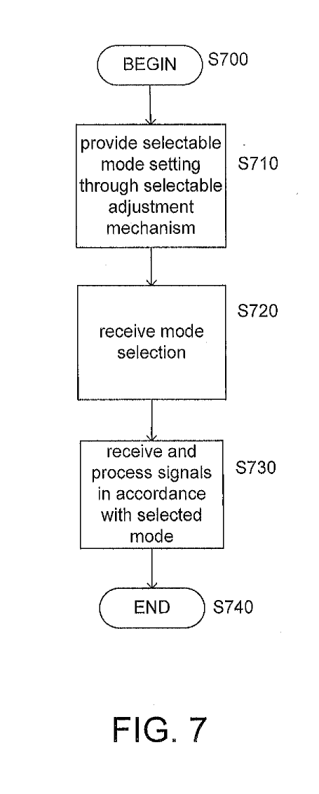

FIG. 7 is a flow chart broadly illustrating a method in accordance with an embodiment of the invention. The method begins in S700 and in S710, a selectable mode setting is provided through the selectable adjustment mechanism as more fully described above. In S720, the mode selection is activated by a system installer or other authorized individual. In S730, in operation, the security system receives and processes signals in accordance with the selected mode. For instance, if the short range mode is selected, the signals are processed as described above in relation to the short range mode. If the long range mode is selected, signals are processed as described above in relation to the long range mode. The method ends in S740.

While particular embodiments of the invention have been illustrated and described in detail herein, it should be understood that various changes and modifications might be made to the invention without departing from the scope and intent of the invention.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. An intrusion detection system comprising:
at least two sensors, each of the sensors having an individual range of coverage; and
at least two predetermined settings for determining a collective coverage range of the at least two sensors; and
a selectable adjustment mechanism for allowing an installer to select an optimal predetermined setting from the at least two predetermined settings for regulating the collective coverage range of the at least two sensors.

2. The intrusion detection system of claim 1, wherein output of the selectable adjustment mechanism is connected with a microprocessor.

3. The intrusion detection system of claim 2, wherein the selectable adjustment mechanism comprises a switch.

4. The intrusion detection system of claim 3, wherein the at least two sensors comprise at least two PIR sensors.

5. The intrusion detection system of claim 4, wherein the microprocessor ignores signals from one PIR sensor when the switch is in a first predetermined position, thereby providing the intrusion detection system with short range coverage.

6. The intrusion detection system of claim 4, wherein the microprocessor processes signals from the at least two PIR sensors when the switch is in a second predetermined position, thereby providing the intrusion detection system with long range coverage.

7. The intrusion detection system of claim 3, wherein the at least two sensors comprise two PIR sensors including an upper channel PIR sensor and a lower channel PIR sensor, and a microwave sensor.

8. The intrusion detection system of claim 7, wherein a first predetermined switch position provides short range coverage, such that when the microprocessor receives an upper PIR signal and fails to detect a lower PIR signal, the microprocessor cancels any received microwave signal.

9. The intrusion detection system of claim 7, wherein when the switch is a first predetermined position, the microprocessor is prohibited from activating an alarm based on signals from the upper channel PIR sensor, providing the intrusion detection system with short range coverage.

10. The intrusion detection system of claim 7, wherein when the switch is in a second predetermined position, the microprocessor processes signals from the two PIR sensors and microwave sensor to provide long range coverage.

11. A method for providing regulation of a coverage range of an intrusion detection system having at least two sensors, each sensor having an individual range of coverage, the method comprising:
providing at least two predetermined settings for determining a collective coverage range of the at least two sensors; and
incorporating a selectable adjustment mechanism, the selectable adjustment mechanism allowing an intrusion detection system installer to select an optimal predetermined setting from the at least two predetermined settings for regulating the collective coverage range of the at least two sensors.

12. The method of claim 11, further comprising providing output of the selectable adjustment mechanism to a microprocessor.

13. The method of claim 12, further comprising utilizing a switch as the selectable adjustment mechanism.

14. The method of claim 13, further comprising providing at least two PIR sensors.

15. The method of claim 14, further comprising ignoring signals from one PIR sensor when the switch is in a first predetermined position, thereby providing the intrusion detection system with short range coverage.

16. The method of claim 15, further comprising processing signals from the at least two PIR sensors when the switch is in a second predetermined position, thereby providing the intrusion detection system with long range coverage.

17. The method of claim 14, wherein the at least two sensors comprise two PIR sensors including an upper channel PIR sensor and a lower channel PIR sensor, and a microwave sensor.

18. The method of claim 14, further comprising canceling any received microwave signal upon receiving an upper PIR signal and failing to detect a lower PIR signal when a first predetermined switch position provides short range coverage.

19. The method of claim 17, further comprising, when the switch is a first predetermined position, prohibiting the microprocessor from activating an alarm based on signals from the upper channel PIR sensor, thereby providing the intrusion detection system with short range coverage.

20. The method of claim 17, further comprising, when the switch is in a second predetermined position, processing signals from the two PIR sensors and microwave sensor to provide long range coverage.
